(19) United States
(12) Patent Application Publication
(10) Pub. No.: US 2023/0390714 A1
(43) Pub. Date: Dec. 7, 2023

(54) AERATING POURING DEVICE

(71) Applicant: FRESHLINK PRODUCT DEVELOPMENT, LLC, Montclair, NJ (US)

(72) Inventors: Michael DICOCCO, Sparta, NJ (US); Dean CHAPMAN, Montclair, NJ (US)

(21) Appl. No.: 17/830,736

(22) Filed: Jun. 2, 2022

(51) Int. Cl. B01F 23/236; B67D 3/00; B01F 33/501; B65D 39/00

(52) U.S. Cl. CPC B01F 23/236; B67D 3/0051; B67D 3/0012; B01F 33/5011; B65D 39/0052; B01F 2101/17

(57) ABSTRACT

An aerating pouring device includes a wine stopper unit fittingly and removably insertable into a wine bottle, a spout unit mounted upon and coaxially rotatable relative to the wine stopper unit, and an interlock unit connected between the wine stopper unit and the spout unit. The spout unit is operable to rotate relative to the wine stopper unit through the interengagement of the interlock unit between a wine pouring position, where an upper wine outlet passage and an upper air inlet passage defined in the spout unit are respectively communicated with a lower wine outlet passage and a lower air inlet passage defined in the stopper unit, and a sealing position, where the spout unit closes the lower wine outlet passage and the lower air inlet passage.

### FIELD

The disclosure relates to a pouring device for simultaneously pouring liquid from a container and mixing air into the liquid, and more particularly to an aerating pouring device used for simultaneously pouring wine from a bottle and decanting the wine.

### BACKGROUND

Typically, wine is decanted by pouring wine from a bottle into a decanter. The wine is poured from a distance of approximately 10-20 cm above the top of the decanter so as to aerate and oxidize the wine on its trajectory from the outlet of the bottle neck to the inlet of the decanter. Another decanting method known in the prior art is to connect a wine pouring spout on a neck of a wine bottle. For example, WO 2015/038215A1 discloses a conventional wine aerator which includes a one-piece spout fitted to the neck of a wine bottle such that wine is directed through the spout and contacts with the air during the pouring wine process. However, the conventional wine aerator fails to seal the wine bottle like a cork once opened, and cannot be disassembled for cleaning, which may result in wine residues therein.

### SUMMARY

Therefore, an object of the disclosure is to provide an aerating pouring device that can alleviate at least one of the drawbacks of the prior art.

According to the disclosure, the aerating pouring device is connectable with a neck of a wine bottle, and includes a wine stopper unit fittingly and removably insertable into the neck in an air-tight connection, a spout unit mounted upon and coaxially rotatable relative to the wine stopper unit, and at least one interlock unit connected between the wine stopper unit and the spout unit. The wine stopper unit defines a lower wine outlet passage and a lower air inlet passage which extend axially therethrough to be in spatial communication with the wine bottle and offset from a central axis of the wine stopper unit. The spout unit has a lower abutting surface which downwardly abuts against the wine stopper unit. The spout unit defines an upper wine outlet passage and an upper air inlet passage which extend upwardly from the lower abutting surface to be in communication with ambient air and offset from a central axis of the spout unit. The interlock unit includes a first engaging structure and a second engaging structure which are respectively disposed on the wine stopper unit and the spout unit and inter-engagable with each other. The spout unit is operable to rotate relative to the wine stopper unit through the inter-engagement between the first engaging structure and the second engaging structure between a wine pouring position, where the upper wine outlet passage and the upper air inlet passage are respectively aligned and communicated with upper ends of the lower wine outlet passage and the lower air inlet passage, and a sealing position, where the upper wine outlet passage and the upper air inlet passage are respectively offset from the lower wine outlet passage and the lower air inlet passage and the lower abutting surface is brought to close the upper ends of the lower wine outlet passage and the lower air inlet passage.

### BRIEF DESCRIPTION OF THE DRAWINGS

Other features and advantages of the disclosure will become apparent in the following detailed description of the embodiment with reference to the accompanying drawings, of which:

FIG. 1 is an exploded perspective view illustrating an embodiment of an aerating pouring device according to the disclosure in a state when a spout unit is in a removable position;

FIG. 2 is a schematic side view illustrating the embodiment mounted on a wine bottle and during the wine pouring process;

FIG. 3 is a fragmentary, exploded perspective view of the embodiment;

FIG. 4 is a fragmentary, sectional view of the embodiment in a state when the spout unit is in a wine pouring position;

FIG. 5 is an exploded perspective view of a portion of the embodiment;

FIG. 6 is a fragmentary perspective view of the embodiment in a state when the spout unit is in the wine pouring position;

FIG. 7 is a cross-sectional view of the embodiment, illustrating that the spout unit is in the wine pouring position relative to a stopper seat;

FIG. 8 is a view similar to FIG. 6, illustrating a state when the spout unit is in a sealing position; and

FIG. 9 is a view similar to FIG. 7, illustrating that the spout unit is in the sealing position relative to the stopper seat.

### DETAILED DESCRIPTION

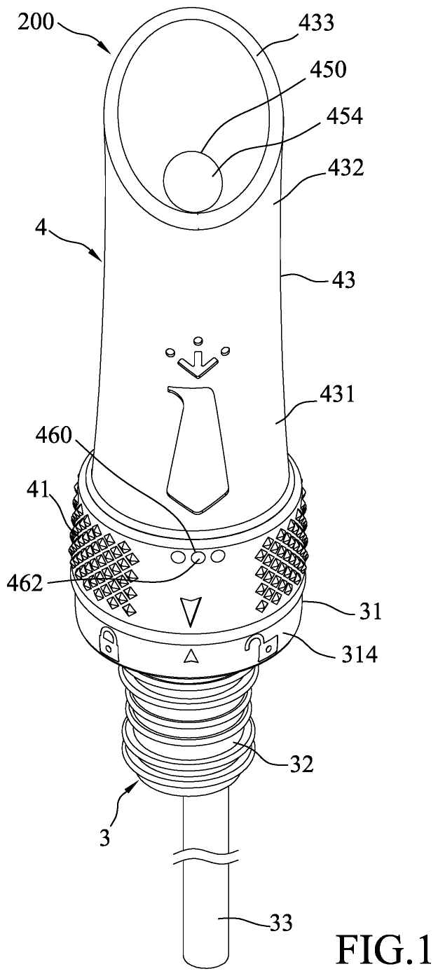

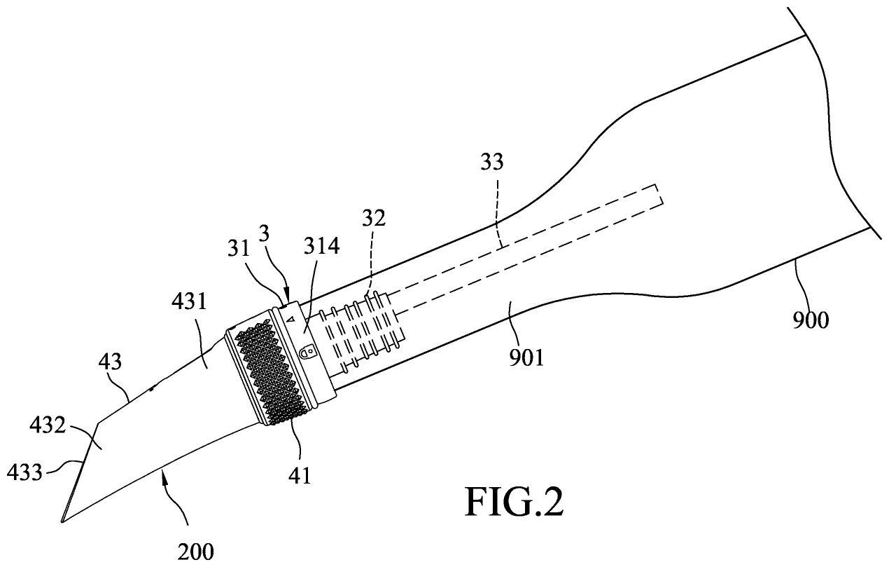

Referring to FIGS. 1 and 2, an embodiment of an aerating pouring device 200 according to the disclosure is connectable with a neck 901 of a wine bottle 900 to permit wine to be aerated through the aerating pouring device 200 while the bottle 900 is tipped to pour the wine.

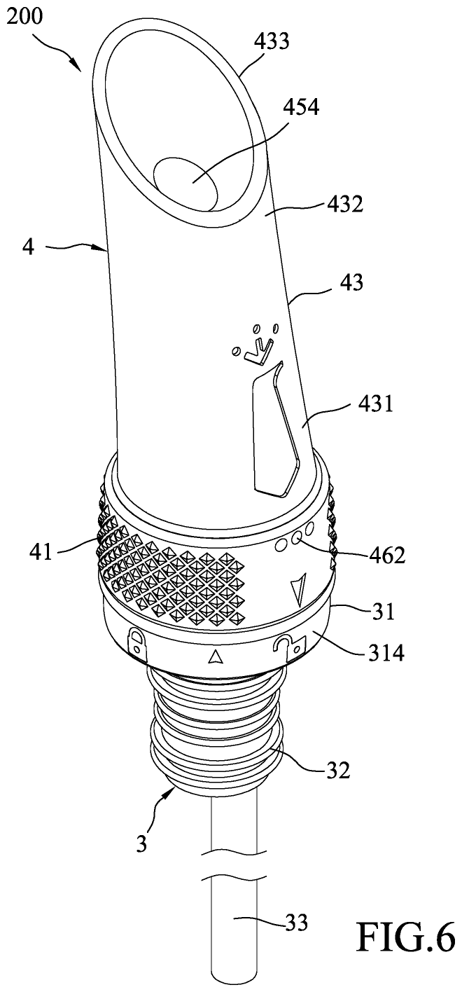

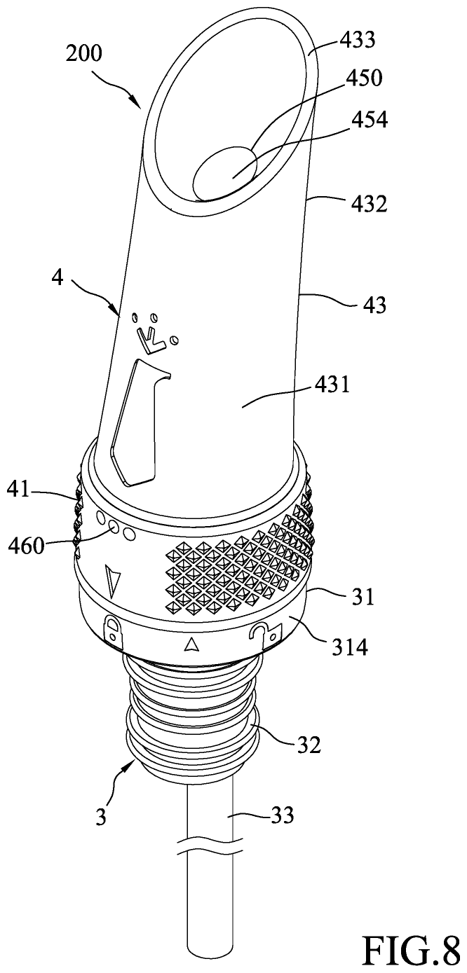

With reference to FIGS. 2, 3 and 4, the aerating pouring device 200 includes a wine stopper unit 3 coaxially insertable into the neck 901, a spout unit 4 mounted upon and coaxially rotatable relative to the wine stopper unit 3, and two interlock units 5 disposed to removably engage the spout unit 4 with the wine stopper unit 3. The spout unit 4 is operable to rotate relative to the wine stopper unit 3 through the interlock units 5 among a sealing position (as shown in FIG. 8), a wine pouring position (as shown in FIG. 6) and a removable position (as shown in FIG. 1).

The wine stopper unit 3 includes a stopper seat 31 extending axially, an overmolding sleeve 32 removably sleeved over the stopper seat 31 to fit into the neck 901 with an air-tight fit, and an extension tube 33 extending axially and having an upper end which is removably connected with and disposed below the stopper seat 31.

The stopper seat 31 has an insert portion 311 on which the overmolding sleeve 32 is sleeved to be inserted into the neck 901, an enlarged flange portion 314 which extends radially from an upper end of the insert portion 311 to abut against the mouth of the neck 901, and a connecting surrounding portion 315 which extends axially from an upper end of the flange portion 314 and coaxial with the insert portion 311. The insert portion 311 extends upwardly and terminates at an upper abutted end 3110, and defines therein a lower wine outlet passage 312 and a lower air inlet passage 313 which axially extend through the insert portion 311 to be in spatial communication with the wine bottle 900 and offset from a central axis of the wine stopper unit 3. The overmolding sleeve 32 is made from an elastomer material such as rubber or silicone, to be fittingly and removably inserted into the neck 901 in an air-tight connection. The extension tube 33 extends axially and has the upper end mounted on the insert portion 311 to be downstream of the lower air inlet passage 313 to allow air to enter into the wine bottle 900.

The spout unit 4 includes a spout seat 42 which has a lower abutting surface 423 downwardly abutting against the upper abutted end 3110 of the insert portion 311, an operating ring 41 which is securely sleeved around the spout seat 42 and rotatably disposed over the connecting surrounding portion 315, an upper spout 43 which is connected with the operating ring 41 and coaxially abutting against the spout seat 42 in an air-tight manner, and two locking assemblies 44 which are disposed to removably engage the upper spout 43 with the operating ring 41. Moreover, the spout unit 4 defines therein an upper wine outlet passage 450 and an upper air inlet passage 460 which extend upwardly from the lower abutting surface 423 to be in communication with ambient air and offset from a central axis of the spout unit 4. The upper wine outlet passage 450 and the upper air inlet passage 460 are formed to be in communication with the lower wine outlet passage 312 and the lower air inlet passage 460, respectively.

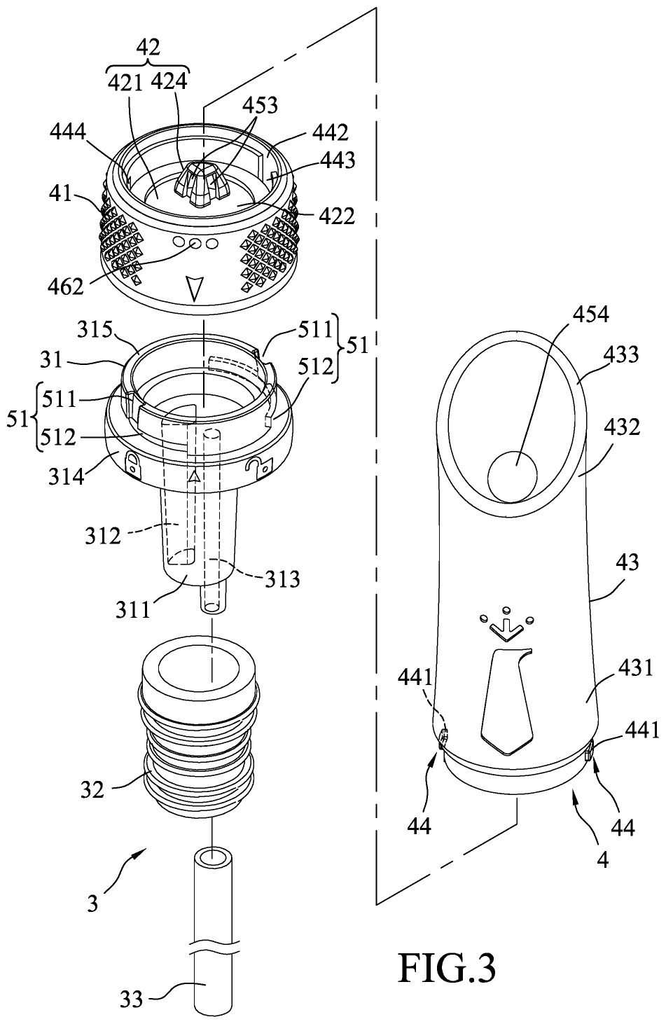

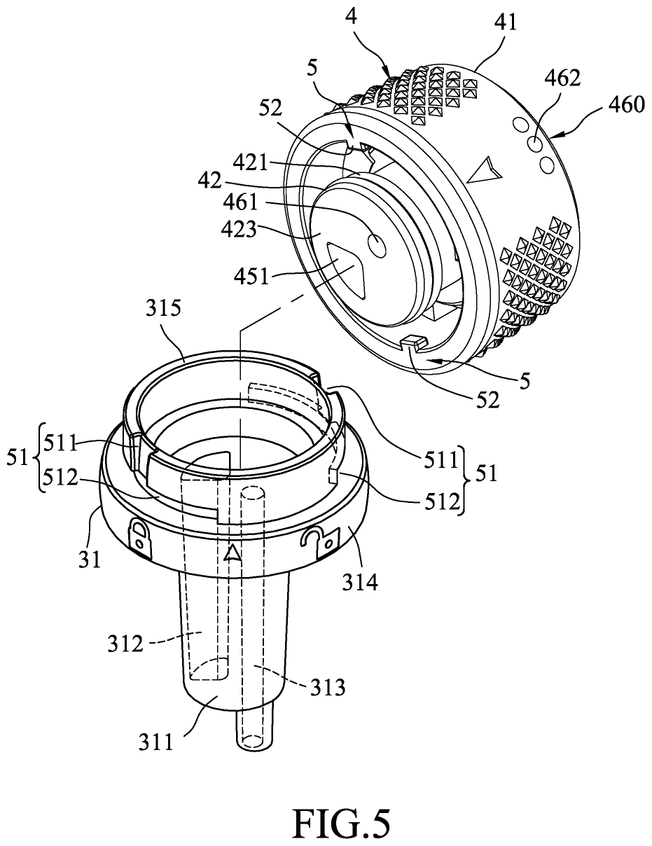

With reference to FIGS. 3 and 5, the two interlock units 5 are disposed diametrically opposite to each other and on peripheral surfaces of the connecting surrounding portion 315 and the operating ring 41 facing each other to permit the operating ring 41 to move together with the spout seat 42 and the upper spout 43 among the sealing position, the wine pouring position and the removable position.

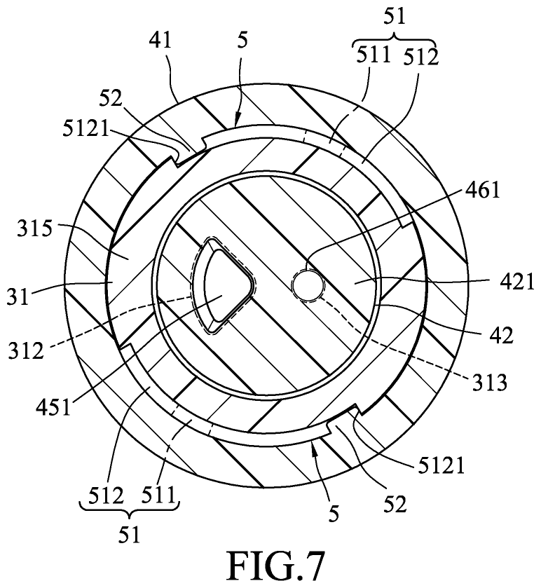

Each interlock unit 5 includes a first engaging structure 51 and a second engaging structure 52 which are respectively disposed on the peripheral surfaces and inter-engagable with each other. In this embodiment, the operating ring 41 surrounds the connecting surrounding portion 315. The first engaging structure 51 is in the form of a slot structure formed in the outer peripheral surface of the connecting surrounding portion 315, and the second engaging structure 52 is in the form of a protrusion structure radially projecting from the inner peripheral surface of the operating ring 41. Specifically, the first engaging structure 51 has a sliding slot 512 which extends along the outer peripheral surface of the connecting surrounding portion 315 and terminates at two stop ends 5121 (see FIG. 7), and an access slot 511 which extends from and is transverse to a middle portion of the sliding slot 512 such that the second engaging structure 52 is entered from the access slot 511 and slidably engaged in the sliding slot 512.

Through the interlock units 5 disposed on the connecting surrounding portion 315 and the operating ring 41, when the spout unit 4 is to be mounted on the connecting surrounding portion 315, the second engaging structures 52 disposed on the operating ring 41 are aligned with the access slots 51 and engaged downwardly in the sliding slots 512 while the operating ring 41 is brought downwardly to abut against the enlarged flange portion 314. At this stage, the spout unit 4 is in the removable position.

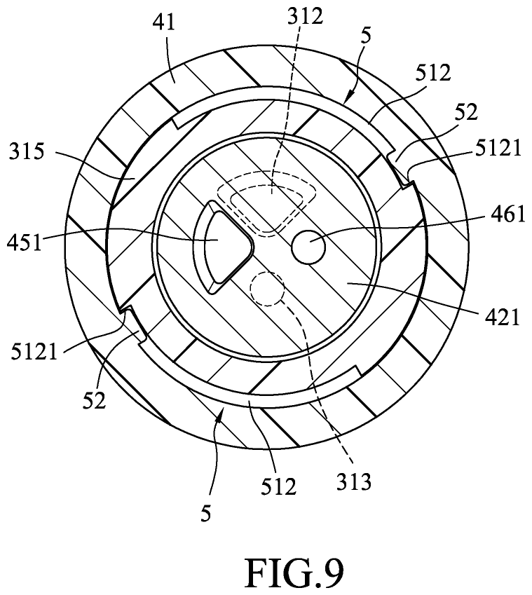

Next, when the operating ring 41 is turned manually counterclockwise relative to the stopper seat 31, the spout unit 4 is turned to the wine pouring position (as shown in FIGS. 6 and 7). At this stage, each second engaging structure 52 is stopped and abuts against one of the stop ends 5121 of the corresponding sliding slot 512. When the operating ring 41 is turned clockwise relative to the stopper seat 31, the spout unit 4 is turned to the sealing position (as shown in FIGS. 8 and 9). At this stage, each second engaging structure 52 is stopped and abuts against the other one of the stop ends 5121.

In another embodiment, the first engaging structure 51 may be in the form of a slot structure formed in the inner peripheral surface of the operating ring 41, and the access slot 511 is opened downwardly such that the second engaging structure 52 which is in the form of a protrusion structure projecting from the outer peripheral surface of the connecting surrounding portion 315 is engaged upwardly in the access slot 511. Alternatively, in various embodiments, the connecting surrounding portion 315 may be sleeved around the operating ring 41. In this case, the first engaging structure 51 and the second engaging structure 52 are respectively disposed on an outer peripheral surface of the operating ring 41 and an inner peripheral surface of the connecting surrounding portion 315 so as to permit rotation of the spout unit 4 relative to the stopper seat 31 among those positions.

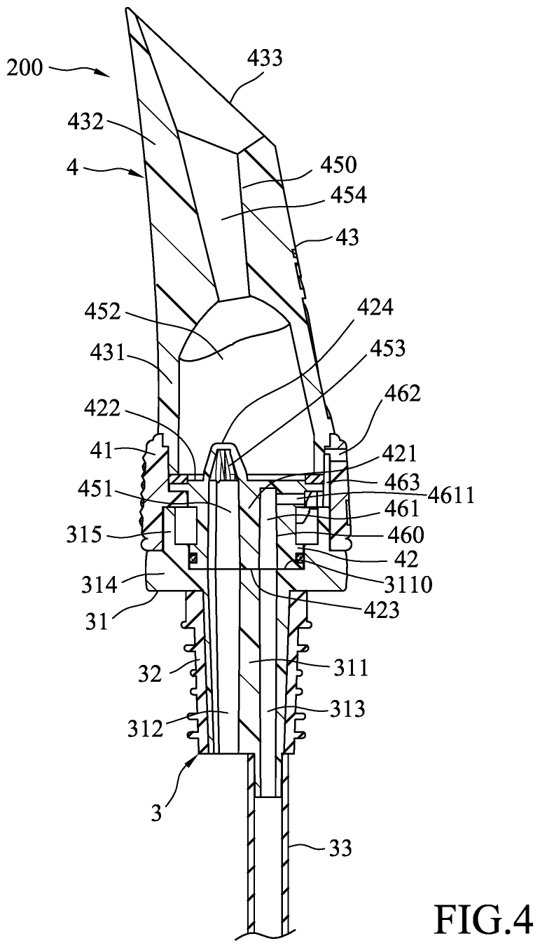

With reference to FIGS. 3 and 4, the spout seat 42 has a seat portion 421 which is coaxially inserted inwardly of the enlarged flange portion 314 in an air-tight engagement, and abuts against the upper abutted end 3110 of the insert portion 311, and a cap portion 424 which is mounted on an upper end surface 422 of the seat portion 421 and opened downwardly. The seat portion 421 has the lower abutting surface 423 opposite to the upper end surface 422 to abut against the upper abutted end 3110. The cap portion 424 is offset from the central axis of the seat portion 421.

The upper spout 43 has a connecting tubular section 431 which is coaxially connected with the operating ring 41 and abuts downwardly against and air-tight engaged with the upper end surface 422 of the spout seat 42 to surround the cap portion 424, and a distal tubular section 432 which extends upwardly from and integrally formed with the connecting tubular section 431. The distal tubular section 432 has a planar truncation edge 433 which extends obliquely to intersect the central axis of the spout unit 4.

The two locking assemblies 44 are disposed diametrically opposite to each other and on the peripheral surfaces of the operating ring 41 and the connecting tubular section 431 facing each other so as to releasably lock the upper spout 43 to the operating ring 41. In this embodiment, each locking assembly 44 has a protrusion 441 which extends radially from the outer peripheral surface of the connecting tubular section 431, and a retaining slot 442 which is formed in the inner peripheral surface of the operating ring 41 and in which the protrusion 441 is movably engaged. The retaining slot 442 has an access slot section 443 which extends axially to permit access of the protrusion 441 to the retaining slot 442, and a retaining slot section 444 which extends transversely and along the periphery of the operating ring 41 to retain the protrusion 441 therein so as to prevent axial removal of the upper spout 43 from the operating ring 41.

Through the locking assemblies 44, the upper spout 43 is engaged downwardly with the operating ring 41 and turned to be locked thereto. The upper spout 43 is also turned to be released from the operating ring 41 and removable upwardly therefrom. In another embodiment, the protrusion 441 and the retaining slot 442 may be disposed on the inner peripheral surface of the operating ring 41 and the outer peripheral surface of the connecting tubular section 431, respectively. Alternatively, the connecting tubular section 431 may be sleeved around the operating ring 41 such that the locking assemblies 44 may be disposed on an inner peripheral surface of the connecting tubular section 431 and an outer peripheral surface of the operating ring 41. Moreover, the spout unit 4 may include only one locking assembly 44 to releasably lock the upper spout 43 to the operating ring 41. The locking assembly 44 may have other variations in structure such as a threadedly engaging structure.

The upper spout 43 cooperates with the spout seat 42 to define the upper wine outlet passage 450 and the upper air inlet passage 460. Specifically, the upper wine outlet passage 450 has an upper communicating section 451 which extends from the lower abutting surface 423 to the upper end surface 422 and offset from the central axis of the seat portion 421, a turbulent section 452 which is defined in the connecting tubular section 431 and the upper end surface 422 of the seat portion 421 and downstream of the upper communicating section 451, a deflecting section 453 which extends transversely through the cap portion 424 and intercommunicates the turbulent section 452 and the upper communicating section 451, and a discharge opening section 454 which is surrounded by the distal tubular section 432 and downstream of the turbulent section 452 and which is formed to flare from the turbulent section 452 to a tip end of the distal tubular section 432. The turbulent section 452 has an inner diameter which is larger than that of a lower end of the discharge opening section 454, and is larger than that of an upper end of the upper communicating section 451 and that of the deflecting section 453. The volume of the tubular section 452 is larger than the sum of the volumes of the lower wine outlet passage 312, the upper communicating section 451 and the deflecting section 453.

The upper air inlet passage 460 has an air intake section 462 which extends radially through the operating ring 41 for flow of ambient air therethrough, an upright communicating section 461 which extends upwardly from the lower abutting surface 423 and which is provided with a radially extending opening 4611 at an outer peripheral surface of the spout seat 42, and a channel section 463 which is defined and interposed between the operating ring 41 and the spout seat 42 and intercommunicates the air intake section 462 and the upright communicating section 461.

With reference to FIGS. 2, 4, 6 and 7, when the aerating pouring device 200 is mounted on the wine bottle 900 and the bottle 900 is to be tipped to pour wine, the spout unit 4 is operated to turn to the wine pouring position. At this stage, the upper communicating section 451 of the upper wine outlet passage 450 and the upright communicating section 461 of the upper air inlet passage 460 are respectively aligned and communicated with upper ends of the lower wine outlet passage 312 and the lower air inlet passage 313. Thus, wine passes through the upper communicating section 451 from the lower wine outlet passage 312, and is then deflected by the deflecting section 453 to flow in the tubular section 452. During flowing of the wine through the deflecting section 453 to the tubular section 452, a turbulence is generated in the tubular section 452 and air can contact with the wine. The wine stays and is accumulated in the tubular section 452 with a relatively large volume compared to a conventional wine aerator, and is discharged outwardly through the discharge opening section 454. With the discharge opening section 454 flaring from the turbulent section 452 to the planar truncation edge 433, the cross-sectional area of the wine in the discharge opening section 454 is gradually increased toward the planar truncation edge 433 to increase the contact surface of the wine with air so as to aerate the wine efficiently.

During the pouring process, with a constricted flow space in the juncture between the tubular section 452 and the discharge opening section 454, a negative pressure generated in the bottle 900 urges the ambient air entering the lower air inlet passage 313 from the upper air inlet passage 460, and is introduced into the bottle 900 through the extension tube 33 such that the wine is smoothly poured out and the introduced air is kept in contact with the wine in the bottle 900.

With reference to FIGS. 4, 8 and 9, when the bottle 900 is upright, the aerating pouring device 200 remains in the bottle 900 and serves as a bottle stopper. The spout unit 4 is operated to turn relative to the wine stopper unit 3 to the sealing position. At this stage, the upper communicating section 451 of the upper wine outlet passage 450 and the upright communicating section 461 of the upper air inlet passage 460 are respectively offset from the lower wine outlet passage 312 and the lower air inlet passage 313, and the lower abutting surface 423 is brought to close the upper ends of the lower wine outlet passage 312 and the lower air inlet passage 313 so as to seal the wine bottle 900.

With reference to FIGS. 1 and 3, when it is desired to clean the aerating pouring device 200, the spout unit 4 is operated to turn relative to the wine stopper unit 3 to the removable position such that the second engaging structures 52 of the interlock units 5 are respectively aligned with the access slots 511 of the first engaging structures 51 to permit removal of the second engaging structures 52 from the sliding slots 512. The spout unit 4 is then removed upwardly from the wine stopper unit 3. Also, the upper spout 43 is turned relative to the operating ring 41 to permit disengagement of the protrusions 441 from the retaining slots 442, and is removed from the operating ring 41. Thus, the component parts of the wine stopper unit 3 and the spout unit 4 are cleaned separately, which is convenient to conduct.

In various embodiments, the upper communicating section 451 is directly communicated with the turbulent section 452 such that the deflecting section 453 of the upper wine outlet passage 450 can be dispensed with. That is, the spout seat 42 is not provided with the cap portion 424.

As illustrated, with the spout unit 4 operable to rotate relative to the wine stopper unit 3 between the wine pouring position and the sealing position, when the aerating pouring device 200 is mounted on a wine bottle 900, it is convenient to aerate wine during pouring, and to seal the bottle 900 when the wine is not poured without the need of a separate bottle stopper. Moreover, through the interlock units 5 connected between the spout unit 4 and the wine stopper unit 3, and the locking assemblies 44 connected between the operating ring 41 and the upper spout 43 of the spout unit 4, the spout unit 4 is removable from the wine stopper unit 3, and the upper spout 43 is removable from the operating ring 41 so as to facilitate a user to the detach component parts for cleaning purposes.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An aerating pouring device connectable with a neck of a wine bottle, comprising:
a wine stopper unit fittingly and removably insertable into the neck in an air-tight connection, and defining a lower wine outlet passage and a lower air inlet passage which extend axially therethrough to be in spatial communication with the wine bottle and offset from a central axis of said wine stopper unit;
a spout unit mounted upon and coaxially rotatable relative to said wine stopper unit, and having a lower abutting surface which downwardly abuts against said wine stopper unit, said spout unit defining an upper wine outlet passage and an upper air inlet passage which extend upwardly from said lower abutting surface to be in communication with ambient air and offset from a central axis of said spout unit; and
at least one interlock unit including a first engaging structure and a second engaging structure which are respectively disposed on said wine stopper unit and said spout unit and inter-engagable with each other, wherein
said spout unit is operable to rotate relative to said wine stopper unit through the inter-engagement between said first engaging structure and said second engaging structure between a wine pouring position, where said upper wine outlet passage and said upper air inlet passage are respectively aligned and communicated with upper ends of said lower wine outlet passage and said lower air inlet passage, and a sealing position, where said upper wine outlet passage and said upper air inlet passage are respectively offset from said lower wine outlet passage and said lower air inlet passage and said lower abutting surface is brought to close said upper ends of said lower wine outlet passage and said lower air inlet passage.

2. The aerating pouring device as claimed in claim 1, wherein said wine stopper unit includes a stopper seat and an overmolding sleeve provided over said stopper seat to have an air-tight fit in the neck, said stopper seat having an insert portion on which said overmolding sleeve is sleeved to be downwardly inserted into the neck, which extends upwardly and terminates at an upper abutted end, and which defines said lower wine outlet passage and said lower air inlet passage therein, and a connecting surrounding portion which is disposed above and coaxial with said insert portion, said spout unit including a spout seat which has said lower abutting surface downwardly abutting against said upper abutted end of said insert portion, an operating ring which is securely sleeved around said spout seat and rotatably disposed over said connecting surrounding portion, and an upper spout which is connected with said operating ring and coaxially disposed above said spout seat, said upper spout cooperating with said spout seat to define said upper wine outlet passage and said upper air inlet passage, said first engaging structure and said second engaging structure being respectively disposed on peripheral surfaces of said connecting surrounding portion and said operating ring facing each other.

3. The aerating pouring device as claimed in claim 2, wherein said first engaging structure has a sliding slot which is formed in and extends along said peripheral surface of said connecting surrounding portion, said second engaging structure projecting from said peripheral surface of said operating ring and being slidably engaged in said sliding slot.

4. The aerating pouring device as claimed in claim 3, wherein said first engaging structure further has an access slot which extends from and transverse to said sliding slot, said operating ring being operable relative to said connecting surrounding portion to shift among the wine pouring position, the sealing position and a removable position, through sliding movement of said second engaging structure along said sliding slot, wherein, in the removable position, said second engaging structure is aligned with said access slot to permit removal of said second engaging structure from said sliding slot.

5. The aerating pouring device as claimed in claim 4, wherein said sliding slot extends along said peripheral surface of said connecting surrounding portion and terminates at two stop ends, said second engaging structure being slidable in and along said sliding slot and abutting against to be stopped by said two stop ends in the wine pouring position and the sealing position, respectively.

6. The aerating pouring device as claimed in claim 5, wherein said aerating pouring device comprises two of said interlock units which are disposed diametrically opposite to each other and on said peripheral surfaces of said connecting surrounding portion and said operating ring.

7. The aerating pouring device as claimed in claim 2, wherein said spout seat further has an upper end surface opposite to said lower abutting surface, said upper spout having a connecting tubular section which is connected with said operating ring and abuts downwardly against and air-tight engaged with said upper end surface of said spout seat, and a distal tubular section which extends upwardly from said connecting tubular section, said upper wine outlet passage having an upper communicating section which extends from said lower abutting surface to said upper end surface, a turbulent section which is defined in said connecting tubular section and said upper end surface and downstream of said upper communicating section, and a discharge opening section which is surrounded by said distal tubular section and downstream of said turbulent section and which is formed to flare from said turbulent section to a tip end of said distal tubular section, said turbulent section having an inner diameter which is larger than that of a lower end of said discharge opening section, and is larger than that of an upper end of said upper communicating section.

8. The aerating pouring device as claimed in claim 7, wherein said spout seat has a seat portion which defines said upper end surface and said lower abutting surface thereon, and a cap portion which is mounted on said upper end surface to be surrounded by said connecting tubular section and opened downwardly, said upper wine outlet passage further having a deflecting section which extends transversely through said cap portion and intercommunicates said turbulent section and said upper communicating section.

9. The aerating pouring device as claimed in claim 7, wherein said connecting tubular section has an outer peripheral surface surrounded by and removably connected with an inner peripheral surface of said operating ring, said spout unit further including at least one locking assembly which is disposed on said outer peripheral surface of said connecting tubular section and said inner peripheral surface of said operating ring to releasably lock said connecting tubular section to said operating ring.

10. The aerating pouring device as claimed in claim 9, wherein said at least one locking assembly has a protrusion which extends radially from one of said outer peripheral surface and said inner peripheral surface, and a retaining slot which is formed in the other one of said outer peripheral surface and said inner peripheral surface and in which said protrusion is movably engaged, said retaining slot having an access slot section which extends axially to permit access of said protrusion to said retaining slot, and a retaining slot section which extends transversely to retain said protrusion therein so as to prevent removal of said upper spout from said operating ring.

11. The aerating pouring device as claimed in claim 10, wherein said spout unit includes two of said locking assemblies which are disposed diametrically opposite to each other and on said outer peripheral surface of said connecting tubular section and said inner peripheral surface of said operating ring.

12. The aerating pouring device as claimed in claim 2, wherein said upper air inlet passage has an air intake section which extends radially through said operating ring for flow of ambient air therethrough, an upright communicating section which extends upwardly from said lower abutting surface and which is provided with a radially extending opening at an outer peripheral surface of said spout seat, and a channel section which is defined and interposed between said operating ring and said spout seat and intercommunicates said air intake section and said upright communicating section.

13. The aerating pouring device as claimed in claim 7, wherein said distal tubular section has a planar truncation edge which extends obliquely to intersect the central axis of said spout unit.

14. The aerating pouring device as claimed in claim 2, wherein said wine stopper unit further includes an extension tube which extends axially and which has an upper end mounted on said insert portion to be downstream of said lower air inlet passage to allow air to enter into the wine bottle.
